(19) United States
(12) Patent Application Publication
(10) Pub. No.: US 2025/0293847 A1
(43) Pub. Date: Sep. 18, 2025

(54) FDD TRANSCEIVER EMPLOYING FREQUENCY-SELECTIVE MULTI-BAND SELF-INTERFERENCE CANCELLATION AND AN ASSOCIATED METHOD

(71) Applicant: ELBIT SYSTEMS C4I AND CYBER LTD., Netanya (IL)

(72) Inventors: Avi LAX, Netanya (IL); Nimrod GINZBERG, Netanya (IL)

(21) Appl. No.: 19/221,578

(22) Filed: May 29, 2025

Related U.S. Application Data
(63) Continuation of application No. PCT/IL2023/051235, filed on Dec. 3, 2023.

(30) Foreign Application Priority Data
Dec. 5, 2022 (IL) 298841

(51) Int. Cl. H04L 5/14; H04B 1/00

(52) U.S. Cl. CPC H04L 5/1461; H04B 1/0064

(57) ABSTRACT

A Frequency-Division Duplex (FDD) transceiver employing frequency-selective multi-band self-interference cancellation is disclosed. The FDD transceiver includes a transmitter and a receiver; a tunable notch filter that is located between a receiver antenna and the receiver, and configured to mitigate or reject a main lobe of a leakage of a transmission signal, output by the transmitter, at the receiver antenna of the receiver; and an adaptive filter, coupled between the transmitter and the receiver, and configured to generate a canceling signal that is injected into the receiver for frequency-selective compensation of the leakage of the transmission signal in at least two receiver bands.

### TECHNICAL FIELD

The invention relates to a Frequency Division Duplex (FDD) transceiver employing frequency-selective multi-band self-interference cancellation and an associated method.

### BACKGROUND

Efficient spectrum utilization in modern wireless communications systems is crucial to overcoming the physical limitations and scarcity of the available wireless spectrum. In FDD operation mode, the transceiver is required to support simultaneous transmission and reception (STAR) in various channel allocations that include close proximity transmission (Tx) and reception (Rx) scenarios where the transmit and receive bands are non-overlapping but not sufficiently separated. In such cases, Tx self-interference cancellation (SIC) at the Rx ports in both the Tx and Rx bands is essential to avoid compression and desensitization of a low noise amplifier (LNA) of the receiver.

### General Description

In accordance with a first aspect of the presently disclosed subject matter, there is provided a method for mitigating self-interference in a Frequency-Division Duplex (FDD) transceiver, the method comprising: outputting, by a transmitter of the FDD transceiver, a transmission signal in a transmission band for transmission by a transmitter antenna; sampling the transmission signal, at the transmitter antenna, to provide a sample transmit signal to an adaptive filter that is coupled between the transmitter and a receiver of the FDD transceiver; mitigating or rejecting, by a tunable notch filter that is located between a receiver antenna and the receiver, a main lobe of a leakage of the transmission signal at the receiver antenna; scaling the sample transmit signal, by the adaptive filter, to generate a canceling signal that is injected into the receiver for frequency-selective compensation, at the receiver, of the leakage of the transmission signal in at least two receiver bands; and combining the canceling signal and an output signal that is associated with an output of the tunable notch filter, resulting in a compensated signal, being the output signal compensated for the leakage of the transmission signal in the receiver bands.

In some cases, the receiver bands are on one side of the transmission band.

In some cases, the receiver bands are at opposite sides of the transmission band.

In some cases, the receiver comprises a plurality of receiver channels, each receiver channel of the receiver channels: (1) being tuned to a distinct receiver band of the receiver bands, and (2) including a narrowband analog-to-digital converter (ADC); wherein, for each receiver channel of the receiver channels, the method further comprises: converting, by the narrowband ADC of the respective receiver channel, a component of the compensated signal that is in the distinct receiver band to which the respective receiver channel is tuned, to provide a digital reception signal.

In some cases, the method further comprises: filtering the compensated signal, by at least two tunable bandpass filters, each tunable bandpass filter of the tunable bandpass filters being configured to pass the component of the compensated signal in one of the receiver bands to the receiver channel that is tuned to the respective receiver band, thereby increasing a selectivity of the receiver channels.

In some cases, sampling the transmission signal at the transmitter antenna also provides a second sample transmit signal, wherein the method further comprises: for each receiver band of the receiver bands, digitizing a component of the second sample transmit signal associated with the respective receiver band, by an additional analog-to-digital converter, to generate a digitized transmission signal component associated with the respective receiver band.

In some cases, the method further comprises: calculating, by a digital controller, based on the digitized transmission signal components associated with the receiver bands and the digital reception signals provided by the receiver channels, a frequency response at each of the receiver bands, the frequency response at each of the receiver bands being defined as a ratio of a magnitude and phase of the digital reception signal that is associated with the respective receiver band to the magnitude and phase of the digitized transmission signal component that is associated with the respective receiver band.

In some cases, the adaptive filter has multiple taps, and the method further comprises: configuring filter weights for each of the taps, by the digital controller, based on the frequency response at each of the receiver bands; and realizing, by the adaptive filter, the filter weights.

In some cases, the digital controller applies a multi-band algorithm at the receiver bands to configure the filter weights.

In some cases, the method further comprises: compensating for the leakage of the transmission signal in the digital reception signals, by the digital controller, based on the frequency response at each of the receiver bands.

In some cases, a second tunable notch filter is provided in series with the adaptive filter, in order to increase a dynamic range of the adaptive filter.

In accordance with a second aspect of the presently disclosed subject matter, there is provided a Frequency-Division Duplex (FDD) transceiver, comprising: a transmitter configured to output a transmission signal in a transmission band for transmission by a transmitter antenna; a receiver; a sampling unit configured to sample the transmission signal, at the transmitter antenna, to provide a sample transmit signal; a tunable notch filter that is located between a receiver antenna and the receiver, the tunable notch filter being configured to mitigate or reject a main lobe of a leakage of the transmission signal at the receiver antenna; and an adaptive filter, coupled between the transmitter and the receiver, and configured to scale the sample transmit signal to generate a canceling signal that is injected into the receiver, for frequency-selective compensation, at the receiver, of the leakage of the transmission signal in at least two receiver bands; wherein the canceling signal is combined with an output signal that is associated with an output of the tunable notch filter, resulting in a compensated signal, being the output signal compensated for the leakage of the transmission signal in the receiver bands.

In some cases, the receiver bands are on one side of the transmission band.

In some cases, the receiver bands are at opposite sides of the transmission band.

In some cases, the receiver comprises: a plurality of receiver channels, each receiver channel of the receiver channels: (1) being tuned to a distinct receiver band of the receiver bands, and (2) including a narrowband analog-to-digital converter (ADC) configured to convert a component of the compensated signal that is in the distinct receiver band, to provide a digital reception signal.

In some cases, the FDD transceiver further comprises: at least two tunable bandpass filters, each tunable bandpass filter of the tunable bandpass filters being configured to pass the component of the compensated signal in one of the receiver bands to the receiver channel that is tuned to the respective receiver band, thereby increasing a selectivity of the receiver channels.

In some cases, the sampling unit is further configured to provide a second sample transmit signal, and the FDD transceiver further comprises: additional analog-to-digital converters (ADCs), each additional ADC of the additional ADCs being configured to digitize a component of the second sample transmit signal associated with a respective receiver band of the receiver bands, to generate a digitized transmission signal component associated with the respective receiver band.

In some cases, the FDD transceiver further comprises: a digital controller configured to calculate, based on the digitized transmission signal components associated with the receiver bands and the digital reception signals provided by the receiver channels, a frequency response at each of the receiver bands, the frequency response at each of the receiver bands being defined as a ratio of a magnitude and phase of the digital reception signal that is associated with the respective receiver band to the magnitude and phase of the digitized transmission signal component that is associated with the respective receiver band.

In some cases, the adaptive filter has multiple taps, wherein the digital controller is further configured to configure filter weights for each of the taps, based on the frequency response at each of the receiver bands, and wherein the adaptive filter is further configured to realize the filter weights.

In some cases, the digital controller is configured to configure the filter weights by applying a multi-band algorithm at the receiver bands.

In some cases, the digital controller is further configured to compensate for the leakage of the transmission signal in the digital reception signals, based on the frequency response at each of the receiver bands.

In some cases, the FDD transceiver further comprises: a second tunable notch filter, provided in series with the adaptive filter, in order to increase a dynamic range of the adaptive filter.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of one example of a software-defined frequency division duplex (FDD) transceiver, in accordance with the presently disclosed subject matter;

FIG. 2 is a schematic illustration of one example of an adjacent channel power ratio (ACPR) of a non-linear power amplifier (PA) of the transmitter and masked desired reception (RX) signals, in accordance with the presently disclosed subject matter; and

FIG. 3 is one example of a sequence of operations for frequency-selective multi-band self-interference cancellation in the FDD transceiver, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “outputting”, “sampling”, “mitigating”, “suppressing”, “rejecting”, “filtering”, “scaling”, “generating”, “injecting”, “combining”, “tuning”, “converting”, “digitizing”, “determining”, “configuring”, “realizing”, “applying”, “providing”, “calculating”, “compensating” or the like, include actions and/or processes, including, inter alia, actions and/or processes of a computer, that manipulate and/or transform data into other data, said data represented as physical quantities, e.g. such as electronic quantities, and/or said data representing the physical objects. The terms “computer”, “processor”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

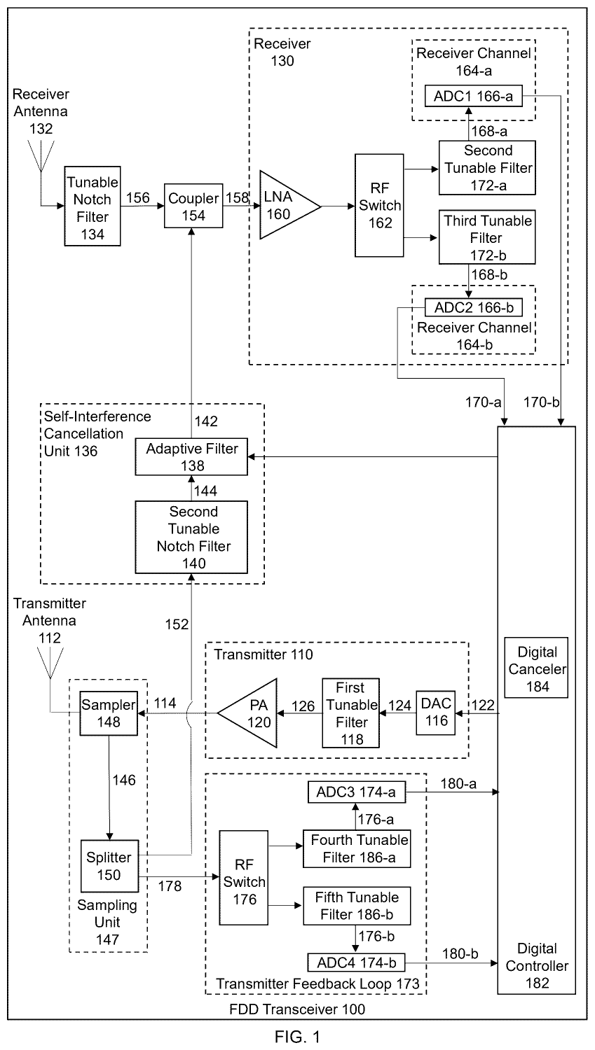

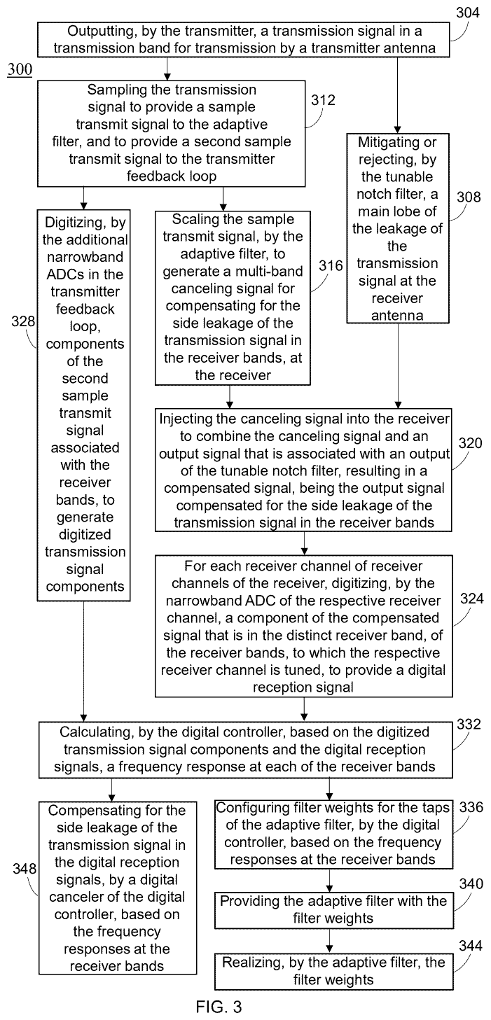

In embodiments of the presently disclosed subject matter, fewer, more and/or different stages than those shown in FIG. 3 may be executed. FIG. 1 illustrates a general schematic of the system architecture in accordance with an embodiment of the presently disclosed subject matter. Each module in FIG. 1 can be made up of any combination of software, hardware and/or firmware that performs the functions as defined and explained herein. In other embodiments of the presently disclosed subject matter, the system may comprise fewer, more, and/or different modules than those shown in FIG. 1.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this is mind, attention is now drawn to FIG. 1, a schematic illustration of one example of a software-defined frequency division duplex (FDD) transceiver 100, in accordance with the presently disclosed subject matter.

In accordance with the presently disclosed subject matter, FDD transceiver 100 is configured to employ a frequency-selective multi-band (e.g., dual-band) self-interference cancellation (SIC) technique. The disclosed SIC technique enables efficient use of the frequency spectrum. Specifically, the disclosed SIC technique enables simultaneous transmission and reception (STAR) operation in close proximity narrowband wireless frequency bands. Moreover, the disclosed SIC technique enables the transmission band and the reception bands to be dynamically selected (i.e., the transmission band and the reception bands do not have to be set ahead of time). The aforesaid benefits of the disclosed SIC technique are not present in known FDD transceivers, in which a duplexer is used to separate between a preset transmission band and a preset reception band that is on one side of the transmission band. In addition, the disclosed SIC technique compensates for self-interference in desired reception signals that are received by the FDD transceiver 100 over a plurality of narrowband wireless frequency bands, including, inter alia, frequency bands that are relatively distant from one another. This is important in FDD systems, in which the reception bands at any given time may be distributed over a relatively wide range of frequency bands.

FDD transceiver 100 is configured to include a transmitter 110 and a receiver 130. Transmitter 110 is coupled to a transmitter antenna 112, and receiver 130 is coupled to a receiver antenna 132 that is different than the transmitter antenna 112. By coupling the transmitter 110 and the receiver 130 to different antennas, spatial passive isolation between the transmitter 110 and the receiver 130 is achieved.

Transmitter 110 is configured to output a transmission signal 114 for transmission by transmitter antenna 112. Transmitter 110 is configured to include a narrowband digital-to-analog converter, DAC, 116 and a power amplifier, PA, 120. DAC 116 is configured to convert a digital transmission signal 122 to an analog transmission signal 124. In some cases, as illustrated in FIG. 1, the analog transmission signal 124 is a Radio Frequency (RF) transmission signal 124. Alternatively, in some cases, following the conversion of the digital transmission signal 122 to an analog transmission signal 124, the analog transmission signal is modulated to form a RF transmission signal.

In some cases, transmitter 110 is configured to filter the RF transmission signal (e.g., 124), by a first tunable bandpass filter 118, in order to output a filtered RF transmission signal 126 with reduced undesired frequency components (e.g., noise) relative to the unfiltered RF transmission signal (e.g., 124). In some cases, the first tunable bandpass filter 118 is a switchable Surface Acoustic Wave (SAW) filter.

PA 120 is configured to amplify the RF transmission signal (124 or 126), whether or not filtered by a first tunable bandpass filter 118, to output the transmission signal 114. The transmission signal 114 includes a desired transmission component in the transmission band. However, due to nonlinear elements in the transmitter 110, the non-linear elements including the PA 120, the transmission signal 114 also includes transmission components (i.e., nonlinear spectral regrowth) that are in other frequency bands at both sides of the transmission band.

Receiver antenna 132 receives a leakage of the transmission signal 114 that is transmitted by transmitter antenna 112. As with the transmission signal 114, the leakage of the transmission signal 114 includes a main lobe in the transmission band, and side leakage in frequency bands at both sides of the transmission band. The leakage of the transmission signal 114 that is received at the receiver antenna 132 is dependent on a frequency-domain transfer function representing the over-the-air leakage between the transmitter antenna 112 and the receiver antenna 132. This frequency-domain transfer function is referred to hereinafter as a Tx-to-Rx leakage transfer function. Concurrently to receiving the leakage of the transmission signal 114, receiver antenna 132 also receives desired reception signals. The desired reception signals are of a magnitude that is well below the magnitude of the main lobe of the leakage of the transmission signal 114, and also below the magnitude of side lobes of the leakage of the transmission signal 114 in frequency bands that are in close proximity to the transmission band.

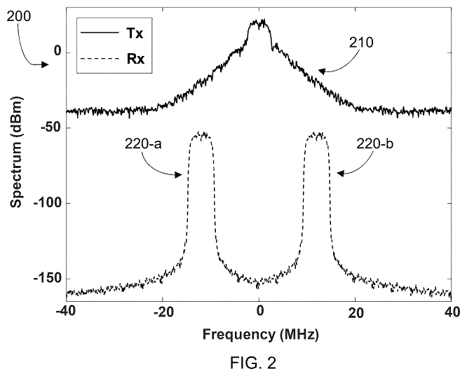

To illustrate this, attention is briefly drawn to FIG. 2, a schematic illustration 200 of one example of an adjacent channel power ratio (ACPR) 210 of the nonlinear PA 120 of the transmitter 110 and masked desired reception (Rx) signals 220-a and 220-b (masked by the leakage of the transmission signal 114), in accordance with the presently disclosed subject matter. The ACPR 210 of the nonlinear PA 120 is a ratio between the total power of the transmission signal 114 at an adjacent frequency band that is adjacent the transmission band (an intermodulation signal) to the power of the transmission signal 114 at the transmission band. Depending on the non-linearity of the PA 120, ACPR 210 can mask several receiver bands on both sides of the transmission band.

FDD transceiver 100 is configured to selectively compensate for (i.e., mitigate, suppress or cancel) the side leakage of the transmission signal 114 that is received at the receiver antenna 132 in the receiver bands of the desired reception signals. The side leakage is compensated in a frequency-selective manner for receiver bands that are proximate to the transmission band and/or distant from the transmission band, as detailed further herein, including, inter alia, with reference to FIG. 3. That is, each of the receiver bands is individually targeted for compensation. The receiver bands include at least two receiver bands, wherein the receiver bands can be on one side of the transmission band or at opposite sides of the transmission band. It is to be noted, in this regard, that known FDD transceivers, which use a duplexer to separate between the transmission band of the FDD transceiver and the receiver band of the FDD transceiver, allow for reception of reception signals only on one side of the transmission band. In the present disclosure, a duplexer is not used to separate between a transmission band of the FDD transceiver 100 and a receiver band of the FDD transceiver 100, and accordingly the FDD transceiver 100 is capable of receiving signals on both sides of the transmission band, including, inter alia, at receiver bands that are symmetric about the transmission band.

It is to be noted that wideband compensation of the entire ACPR 210, rather than only parts of the ACPR 210 that are at the receiver bands (as in the present disclosure), is not practical for FDD transceivers 100 having diversely allocated narrowband frequency bands, due to the dynamic range limitations of the wideband instrumentation, including high speed and expensive ADCs, that would be required to compensate the entire ACPR 210. Such widespread instrumentation also is impractical in FDD transceivers having diversely allocated narrowband frequency bands due to the high-power consumption and cost associated therewith.

Returning to the FDD transceiver 100, in order for the FDD transceiver 100 to selectively compensate for the side leakage of a transmission signal 114 in the reception bands of concurrently received desired reception signals, the energy of the main lobe of the leakage of the transmission signal 114 is to be rejected, or at least mitigated. This is because the main lobe is several orders of magnitude greater than the desired reception signals, for example, as illustrated in FIG. 2. In this regard, it is noted that there is no need for the receiver 130 to process signal components in the transmission band, as the receiver bands are distinct from the transmission band. In order to reject, or at least mitigate, the energy of the main lobe of the leakage of the transmission signal 114, and given that there is no need for the receiver 130 to process signal components in the transmission band, FDD transceiver 100 is configured to include a tunable notch filter 134 that is located between the receiver antenna 132 and the receiver 130, the tunable notch filter 134 being tuned to the transmission band, e.g., the center frequency of the transmission signal 114. By tuning the tunable notch filter 134 to the transmission band, tunable notch filter 134 is configured to preferably reject, or at least mitigate, the main lobe of the leakage of the transmission signal 114. This enables the FDD transceiver 100 to selectively compensate for the side leakage of the transmission signal 114 in the reception bands. In some cases, the tunable notch filter 134 comprises variable LC (inductor-capacitor) units.

In order to selectively compensate for the side leakage of the transmission signal 114 in the reception bands, FDD transceiver 100 is configured to include a self-interference cancellation unit 136. Self-interference cancellation unit 136 is configured to include an adaptive filter 138, and, in some cases, a second tunable notch filter 140.

Adaptive filter 138 is a multi-tap filter. In one non-limiting example, the adaptive filter 138 is an 8-tap filter. The adaptive filter 138 has a complex filter weight at each of the taps of the adaptive filter 138. In some cases, the adaptive filter 138 is an analog multi-tap Finite Impulse Response (FIR) filter. However, the adaptive filter 138 in the present disclosure is not limited to being a FIR filter. In some cases, the adaptive filter 138 operates at a Radio Frequency (RF) domain. In other cases, the adaptive filter 138 operates at baseband (e.g., a downconverter and an upconverter (not shown in FIG. 1) are provided in the self-interference cancellation unit 136).

Adaptive filter 138 is configured to generate a multi-band (e.g., dual-band) canceling signal 142 for compensating, at the receiver 130 (for example, at the input of the receiver 130, as illustrated in FIG. 1), for the side leakage of the transmission signal 114 in the receiver bands. Adaptive filter 138 is configured to scale a sample transmit signal 144 to generate the canceling signal 142, in accordance with the filter weights at the taps of the adaptive filter 138. The sample transmit signal 144 is based on a sample 146 of the transmission signal 114 that is sampled at the transmitter antenna 112.

In order to provide the sample transmit signal 144 to the adaptive filter 138, a sample 146 of the transmission signal 114 is sampled at the transmitter antenna 112, by a sampler 148, for example, a directional coupler. In some cases, the sample 146 of the transmission signal 114 that is sampled at the transmitter antenna 112 is further attenuated, e.g., by a splitter 150, to provide the sample transmit signal 144. The sampler 148 and the splitter 150 form a sampling unit 147. In some cases (not as illustrated in FIG. 1), the sample 146 of the transmission signal 114 at the transmitter antenna 112, whether or not further attenuated, e.g., by splitter 150, is the sample transmit signal 144 that is provided to the adaptive filter 138. This sample transmit signal 144, being the transmission signal 114, as attenuated, includes a main lobe at the transmission band that corresponds to the main lobe of the transmission signal 114 and side lobes at the reception bands that correspond to the side lobes of the transmission signal 114 at the reception bands. Alternatively, in some cases, as illustrated in FIG. 1, self-interference cancellation unit 136 is configured to include a second tunable notch filter 140 in series with the adaptive filter 138 and preceding the adaptive filter 138. The second tunable notch filter 140 is configured to receive an attenuated transmission signal 152, the attenuated transmission signal 152 being a sample 146 of the transmission signal 114 at the transmitter antenna 112, optionally, as further attenuated, e.g., by a RF splitter 150. Second tunable notch filter 140 is configured to be tuned to the transmission band, e.g., the center frequency of the transmission signal 114, in order to preferably reject, or at least mitigate, the main lobe of the attenuated transmission signal 152 that is at the transmission band. In this manner, the dynamic range of the adaptive filter 138 is increased, thereby enabling the transmission and reception of signals by the FDD transceiver 100 over a wider frequency spectrum.

Following the generation of the canceling signal 142 by the adaptive filter 138, the canceling signal 142 is injected into the receiver 130, e.g., using a directional coupler 154. An output signal 156 that is associated with an output of the tunable notch filter 134 also is input to the receiver 130, e.g., using directional coupler 154, resulting in the combination of the canceling signal 142 with the output signal 156. In some cases, the output signal 156 is the output of the tunable notch filter 134, as illustrated in FIG. 1. The combination of the canceling signal 142 and the output signal 156 results in a compensated signal 158, the compensated signal 158 being the output signal 156 as compensated for the side leakage of the transmission signal 114 in the receiver bands. As detailed earlier herein, the tunable notch filter 134 rejects, or at least mitigates, the main lobe of the leakage of the transmission signal 114 at the receiver antenna 132. The removal (or significant removal) of the energy of the main lobe, by the tunable notch filter 134, enables the compensation of the side leakage of the transmission signal 114 in the receiver bands. It is to be noted that the adaptive filter 138 has large delay capabilities, allowing for the adaptive filter 138 to timely inject the canceling signal 142 into the receiver 130 in order to compensate for the side leakage.

Turning to the receiver 130, receiver 130 is configured to include a Low Noise Amplifier, LNA, 160, a Radio Frequency, RF, switch 162, and at least two narrowband and highly-selective receiver channels 164 (e.g., receiver channel 164-a, receiver channel 164-b, etc.) having a high dynamic range. LNA 160 is configured to amplify the compensated signal 158 without significantly degrading its signal-to-noise ratio (SNR). RF switch 162 is configured to provide the compensated signal 158 or a frequency-selective component thereof (a component of the compensated signal 158 at one of the receiver bands) to each receiver channel (e.g., 164-a, 164-b) of the receiver channels 164, in some cases, via tunable bandpass filters, as detailed below. Each of the receiver channels 164 is configured to process signals in a respective receiver band of the receiver bands over which the desired reception signals are received. Each of the receiver channels 164 includes an analog-to-digital converter (e.g., ADC1 166-a, ADC2 166-b, etc.) that is configured to digitize a component (e.g., 168-a, 168-b) of the compensated signal 158 in the respective receiver channel (e.g., 164-a, 164-b) to provide a digital reception signal (e.g., 170-a, 170-b). The ADCs (e.g., 166-a, 166-b, etc.) in the receiver channels 164 are low-speed and economic ADCs. This is possible due to the frequency-selective filter response of the adaptive filter 138. In order to increase the selectivity of the receiver channels 164, in some cases, receiver 130 is configured to include a filter bank comprising at least two tunable bandpass filters (e.g., second tunable bandpass filter 172-a, third tunable bandpass filter 172-b). Each of the tunable bandpass filters (172-a, 172-b) is tuned to a distinct receiver band of the receiver bands to provide a component (e.g., 168-a, 168-b) of the compensated signal 158 to a respective receiver channel (e.g., 164-a, 164-b) of the receiver channels 164, in accordance with the receiver band associated with the respective receiver channel (e.g., 164-a, 164-b). In some cases, the tunable bandpass filters (e.g., 172-a, 172-b) are switchable SAW filters.

In order to determine the filter weights at the taps of the adaptive filter 138, the Tx-to-Rx leakage transfer function associated with the receiver bands (e.g., the center frequencies of the receiver bands) is determined. The Tx-to-Rx leakage transfer function represents the over-the-air leakage between the transmitter antenna 112 and the receiver antenna 132. In order to determine the Tx-to-Rx leakage transfer function associated with the receiver bands, a frequency response for each of the receiver bands is calculated. The frequency response at each of the receiver bands is a ratio of a magnitude and phase of the digital reception signal (e.g., 170-a, 170-b) that is associated with the respective receiver band (i.e., is output by a receiver channel (e.g., 164-a, 164-b) associated with the respective receiver band) to the magnitude and phase of the component of the transmission signal 114 at the respective receiver band. As noted earlier herein, the components of the transmission signal 114 at the receiver bands are a result of non-linearities in the transmitter 110.

In order to determine the magnitude and phase of the components of the transmission signal 114 at each of the receiver bands, FDD transceiver 100 is configured to include a transmitter feedback loop 173. Transmitter feedback loop 173 is configured to include a plurality of additional narrowband analog-to-digital converters, ADCs (e.g., ADC3 174-a, ADC4 174-b, etc.). Each of the additional narrowband ADCs (e.g., 174-a, 174-b) is included in a pseudo-receiver channel (circuitry that includes the same functionality as a receiver channel) (not shown in FIG. 1) that is tuned to one of the receiver bands. Each additional narrowband ADC of the additional narrowband ADCs (e.g., 174-a, 174-b) is configured to digitize a component (e.g., 176-a, 176-b) of a second sample transmit signal 178, to generate a respective digitized transmission signal component (e.g., 180-a, 180-b) associated with a respective receiver band of the receiver bands. The second sample transmit signal 178 is a sample 146 of the transmission signal 114, optionally further attenuated, e.g., by splitter 150, as illustrated in FIG. 1. The magnitude and phase of the components of the transmission signal 114 at the receiver bands is determined based on the digitized transmission signal components (e.g., 180-a, 180-b).

Transmitter feedback loop 173 is further configured to include an additional RF switch 176. Additional RF switch 176 is configured to provide the second sample transmit signal 178 or a frequency-selective component thereof (a component of the second sample transmit signal 178 at one of the receiver bands) to each of the additional narrowband ADCs (e.g., 174-a, 174-b). In some cases, in order to increase the selectivity of the additional narrowband ADCs (e.g., 174-a, 174-b), the second sample transmit signal 178 is bandpass filtered by additional tunable bandpass filters (e.g., fourth tunable bandpass filter 186-a, fifth tunable bandpass filter 186-b, etc.) in a second tunable bandpass filter bank (not shown in FIG. 1). Each of the additional tunable bandpass filters (e.g., 186-a, 186-b) is configured to bandpass filter the second sample transmit signal 178 to provide a component (e.g., 176-a, 176-b) of the second sample transmit signal 178 in a respective receiver band of the receiver bands. Each of the additional ADCs (e.g., 174-a, 174-b) receives, from a respective additional tunable bandpass filter of the additional tunable bandpass filters (e.g., 186-a, 186-b), a component of the second sample transmit signal 178 in a respective receiver band of the receiver bands for the digitization thereof. In some cases, the additional tunable bandpass filters (e.g., 186-a, 186-b) are switchable SAW filters. It is to be noted that, in some cases, the first tunable bandpass filter 118 and the additional tunable bandpass filters (e.g., 186-a, 186-b) are in the second tunable bandpass filter bank.

FDD transceiver 100 is configured to include a digital controller 182. In some cases, digital controller 182 includes one or more integrated circuits. In some cases, digital controller 182 includes one or more programmable components. In some cases, digital controller 182 includes (or is) a field-programmable gate array (FPGA).

Digital controller 182 is configured to perform digital back-end processing of data to be transmitted and received data. Digital controller 182 is also configured, based on: (i) the digitized transmission signal components (e.g., 180-a, 180-b) associated with the receiver bands and (ii) the digital reception signals (e.g., 170-a, 170-b), to calculate the frequency response at each of the receiver bands. The frequency response at each of the receiver bands is defined as a ratio of a magnitude and phase of the digital reception signal (e.g., 170-a, 170-b) that is associated with the respective receiver band to the magnitude and phase of the digitized transmission signal component (e.g., 180-a, 180-b) that is associated with the respective receiver band.

Digital controller 182 is further configured, based on the frequency response at each of the receiver bands, to determine the Tx-to-Rx leakage transfer function associated with the receiver bands (e.g., the center frequencies of the receiver bands), as detailed further herein, inter alia with reference to FIG. 3. In addition, digital controller 182 is configured, based on the Tx-to-Rx leakage transfer function associated with the receiver bands, to determine the filter weights at the taps of the adaptive filter 138, as detailed further herein, inter alia with reference to FIG. 3. Digital controller 182 is configured to provide the filter weights to the adaptive filter 138, which, in turn, realizes the filter weights.

Moreover, in some cases, digital controller 182 is configured to include a digital canceler 184. Digital canceler 184 is configured to compensate for, and preferably cancel, the side leakage of the transmission signal 114 in the digital reception signals (e.g., 170-a, 170-b), based on the frequency responses at the receiver bands.

Attention is now drawn to FIG. 3, one example of a sequence of operations 300 for frequency-selective multi-band self-interference cancellation in the FDD transceiver 100, in accordance with the presently disclosed subject matter.

In accordance with the presently disclosed subject matter, transmitter 110 of the FDD transceiver 100 is configured to output a transmission signal 114 in a transmission band for transmission by a transmitter antenna 112 (block 304). A leakage of the transmission signal 114 is received at a receiver antenna 132 that is coupled to the receiver 130 of the FDD transceiver 100. The transmission signal 114 includes a desired transmission component in the transmission band. However, due to nonlinear elements in the transmitter 110, the non-linear elements including the PA 120, the transmission signal 114 also includes transmission components (i.e., nonlinear spectral regrowth) that are in other frequency bands at both sides of the transmission band. As with the transmission signal 114, the leakage of the transmission signal 114 includes a main lobe in the transmission band, and side leakage in frequency bands at both sides of the transmission band.

A tunable notch filter 134 that is coupled between the receiver antenna 132 and the receiver 130 is tuned to the transmission band, e.g., the center frequency of the transmission signal 114, in order mitigate or reject the main lobe of the leakage of the transmission signal 114 at the receiver antenna 132, as detailed earlier herein, inter alia with reference to FIG. 1 (block 308). The removal (or significant removal) of the energy of the main lobe, by the tunable notch filter 134, enables the FDD transceiver 100 to selectively compensate for (i.e., mitigate, suppress or cancel) the side leakage of the transmission signal 114, at the receiver 130, in the reception bands of the reception signals that are received by the receiver 130 concurrently to the transmission of the transmission signal 114. In some cases, the tunable notch filter 134 comprises variable LC (inductor-capacitor) units.

FDD transceiver 100 is configured to sample the transmission signal 114 to provide a sample transmit signal 144 to an adaptive filter 138 of a self-interference cancellation unit 136, and to provide a second sample transmit signal 178 to a transmitter feedback loop 173, as detailed earlier herein, inter alia with reference to FIG. 1 (block 312).

Adaptive filter 138, being a multi-tap filter (e.g., an 8-tap filter), is configured to scale the sample transmit signal 144 to generate a multi-band (e.g., dual-band) canceling signal 142. The sample transmit signal 144 is scaled, by the adaptive filter 138, in accordance with the complex filter weights at the taps of the adaptive filter 138 (each of the taps of the adaptive filter 138 has a complex filter weight). The canceling signal 142 compensates for (i.e., mitigates, suppresses or cancels) the side leakage of the transmission signal 114 in the receiver bands, at the receiver 130 (block 316).

In some cases, the adaptive filter 138 is an analog multi-tap Finite Impulse Response (FIR) filter. However, the adaptive filter 138 in the present disclosure is not limited to being a FIR filter. In some cases, the adaptive filter 138 operates at a Radio Frequency (RF) domain. In other cases, the adaptive filter 138 operates at baseband (e.g., a downconverter and an upconverter are provided in the self-interference cancellation unit 136).

In some cases, a second tunable notch filter 140 is included in the self-interference cancellation unit 136. The second tunable notch filter 140 is tuned to the transmission band of the transmission signal, e.g., the center frequency of the transmission signal 114, in order to reject or at least mitigate the main lobe in the sample of the transmission signal 114, as detailed earlier herein, inter alia with reference to FIG. 1. The second tunable notch filter 140 is located in series with the adaptive filter 138 and precedes the adaptive filter 138, resulting in an increased dynamic range for the adaptive filter 138. This enables the transmission and reception of signals by the FDD transceiver 100 over a wider frequency spectrum.

Returning to the sequence of operations 300, FDD transceiver 100 is configured to inject the canceling signal 142 into the receiver 130 (e.g., at an input of the LNA 160), e.g., using directional coupler 154, to combine the canceling signal 142 and an output signal 156 that is associated with an output of the tunable notch filter 134. In some cases, the output signal 156 is the output of the tunable notch filter 134. The combination of the canceling signal 142 and the output signal 156 compensates for the side leakage of the transmission signal 114 in the receiver bands, resulting in a compensated signal 158. The compensated signal 158 is the output signal 156 compensated for the side leakage of the transmission signal 114 in the receiver bands (block 320). It is to be noted that the adaptive filter 138 has large delay capabilities, allowing for the adaptive filter 138 to timely inject the canceling signal 142 into the receiver 130 in order to compensate for the side leakage.

Receiver 130 is configured to include at least two narrowband and highly-selective receiver channels 164, each receiver channel (e.g., 164-a, 164-b, etc.) of the receiver channels 164: (1) being tuned to a distinct receiver band of the receiver bands, and (2) including a narrowband analog-to-digital converter, ADC (e.g., ADC1 166-a, ADC2 166-b, etc.). For each receiver channel (e.g., 164-a, 164-b, etc.) of the receiver channels 164, the narrowband ADC (e.g., 166-a, 166-b) of the respective receiver channel (e.g., 164-a, 164-b) is configured to digitize a component (e.g., 168-a, 168-b) of the compensated signal 158 that is in the distinct receiver band, of the receiver bands, to which the respective receiver channel (e.g., 164-a, 164-b) is tuned, to provide a digital reception signal (e.g., 170-a, 170-b) (block 324).

In some cases, receiver 130 is further configured to include a tunable bandpass filter bank including at least two tunable bandpass filters (e.g., 172-a, 172-b). Each tunable bandpass filter of the tunable bandpass filters (e.g., 172-a, 172-b) is configured to pass a component (e.g., 168-a, 168-b) of the compensated signal 158 in one of the receiver bands to the receiver channel (e.g., 164-a, 164-b) that is tuned to the respective receiver band, thereby increasing a selectivity of the receiver channel (e.g., 164-a, 164-b). In some cases, the tunable bandpass filters (e.g., 172-a, 172-b) are switchable SAW filters.

Returning to the sequence of operations 300, FDD transceiver 100 is configured to digitize, by each additional narrowband ADC of additional narrowband ADCs (e.g., 174-a, 174-b) in the transmitter feedback loop 173, a component (e.g., 176-a, 176-b) of the second sample transmit signal 178 associated with a respective receiver band of the receiver bands, to generate a respective digitized transmission signal component (e.g., 180-a, 180-b) associated with the respective receiver band (block 328). In some cases, in order to increase the selectivity of the additional narrowband ADCs (e.g., 174-a, 174-b), the second sample transmit signal 178 is bandpass filtered by additional tunable bandpass filters (e.g., 186-a, 186-b) in a second tunable bandpass filter bank. Each of the additional tunable bandpass filters (e.g., 186-a, 186-b) is configured to bandpass filter the second sample transmit signal 178 to provide a component (e.g., 176-a, 176-b) of the second sample transmit signal 178 to a respective additional ADC of the additional ADCs (e.g., 174-a, 174-b) for the digitization thereof. In some cases, the additional tunable bandpass filters (e.g., 186-a, 186-b) are switchable SAW filters. It is to be noted that, in some cases, the first tunable bandpass filter 118 and the additional tunable bandpass filters (e.g., 186-a, 186-b) are in the second tunable bandpass filter bank.

Digital controller 182 is configured, based on the digitized transmission signal components (e.g., 180-a, 180-b) and the digital reception signals (e.g., 170-a, 170-b), to calculate a frequency response at each of the receiver bands (block 332). The frequency response at each of the receiver bands is defined as a ratio of a magnitude and phase of the digital reception signal (e.g., 170-a, 170-b) that is associated with the respective receiver band to the magnitude and phase of the digitized transmission signal component (e.g., 180-a, 180-b) that is associated with the respective receiver band. In some cases, digital controller 182 includes one or more integrated circuits. In some cases, digital controller 182 includes one or more programmable components. In some cases, digital controller 182 includes (or is) a field-programmable gate array (FPGA).

Digital controller 182 is further configured, based on the frequency responses at the receiver bands, to configure filter weights for the taps of the adaptive filter 138 (block 336). Specifically, digital controller 182 is configured, based on the frequency responses at the receiver bands, to determine the Tx-to-Rx leakage transfer function associated with the receiver bands (e.g., associated with the center frequencies of the receiver bands). The Tx-to-Rx leakage transfer function is a frequency-domain transfer function representing the over-the-air leakage between the transmitter antenna 112 and the receiver antenna 132. To explain how the Tx-to-Rx leakage transfer function is determined, it is noted that the FDD transceiver 100 operates in a frequency spectrum including N frequency bands. A frequency vector is provided, the frequency vector including entries representing frequency responses at each of the frequency bands in the frequency spectrum. This frequency vector is to be populated. However, since we are only interested in the frequency responses at the receiver bands, the entries in the frequency vector that are associated with the receiver bands are populated with the frequency responses at the receiver bands while the entries in the frequency vector that are not associated with the receiver bands are padded with zeros. The selectively populated frequency vector is the Tx-to-Rx leakage transfer function.

The adaptive filter 138 has a known discrete frequency-domain transfer function, referred to hereinafter as an adaptive filter transfer function. This is because the adaptive filter transfer function is calibrated prior to the regular operation of the FDD transceiver 100. The adaptive filter transfer function is represented by a (N−1)×m matrix, wherein N is the number of frequency bands in the frequency spectrum over which the FDD transceiver 100 operates, and wherein m E {1, . . . , M} are the filter weight indices for the taps of the adaptive filter 138.

Digital controller 182 is configured, based on the Tx-to-Rx leakage transfer function associated with the receiver bands and the adaptive filter transfer function associated with the receiver bands, to configure the filter weights at the taps of the adaptive filter 138. The adaptive filter transfer function associated with the receiver bands is determined by populating the entries in the (N−1)×m matrix that are associated with the receiver bands while padding the entries that are not associated with the receiver bands with zeros. The filter weights are determined to conform (or attempt to conform) the frequency response of the adaptive filter that is associated with the receiver bands to the Tx-to-Rx leakage function associated with the receiver bands. That is, the filter weights are configured by applying a multi-band (e.g., dual-band) algorithm at the receiver bands. In some cases, the multi-band algorithm is a Recursive Least Squares (RLS) algorithm. By applying a multi-band algorithm to configure the filter weights, the sampling rate in the receiver bands is reduced, taking advantage of the narrowband characteristics of the receiver channels (e.g., 164-a, 164-b) to operate at low ADC speeds.

The following is an explanation of one (non-limiting) embodiment of an operation to determine the filter weights. Let us denote by hₗₑₐₖ(k) and h_{FIR,m}(k) the Tx-to-Rx leakage function and the adaptive filter transfer function, respectively. k∈{0, . . . , N−1} are the Discrete Fourier Transform (DFT) frequency bins representing discrete frequencies fₖ=kfₛ/N where N is the DFT size and fₛ is the adaptive (FIR) filter's baseband bandwidth, and m∈{1, . . . ,M} are the M-tap FIR filter weights indices. It is desired to find FIR filter weights, wₘ, which yield a close approximation of hₗₑₐₖ(k) when multiplied by h_{FIR,m}(k), as follows:

$${{\sum }_{m = 1}}^{M} {h}_{FIR , m} ( k ) {w}_{m} = {h}_{leak} ( k ) \qquad ( 1 )$$

In the general case, (1) can be written using a matrix representation:

$${{h}_{FIR}^{[ N \times M ]}}_{} {w}^{[ M \times 1 ]} = {h}_{leak}^{[ N \times 1 ]} \qquad ( 2 )$$

Writing (2) explicitly yields:

$$( \begin{matrix}{h}_{FIR , 0 , 1} & ⋯ & {h}_{FIR , 0 , M} \\ ⋮ & ⋱ & ⋮ \\ {h}_{FIR , N - 1 , 1} & ⋯ & {h}_{FIR , N - 1 , M}\end{matrix} ) ( \begin{matrix}{ω}_{1} \\ ⋮ \\ {ω}_{M}\end{matrix} ) = ( \begin{matrix}{h}_{leak , 0} \\ ⋮ \\ {h}_{leak , N - 1}\end{matrix} ) \qquad ( 3 )$$

where h_{FIR,k,m} is an (N−1)×m matrix, wₘ is an M vector of complex filter weights, and h_{leak,k} is a frequency vector with N−1 frequency bins.

For frequency-selective cancellation in two receiver bands within the FIR filter's baseband bandwidth, h_{FIR,k,m} and h_{leak,k} are populated with the corresponding Discrete Fourier Transform (DFT) samples of each of the receiver bands, while all other bands that are not of interest are padded with zeros. After populating h_{FIR,k,m} and h_{leak,k}, the filter weights in the M vector of complex filter weights are calculated.

Following the calculation of the complex filter weights, digital controller 182 is configured to provide the filter weights to the adaptive filter 138 (block 340).

Adaptive filter 138 is configured to realize the filter weights that are provided to the adaptive filter 138 (block 344).

In some cases, digital controller 182 is configured to include a digital canceler 184. Digital canceler 184 is configured to compensate for, and preferably cancel, the side leakage of the transmission signal in the digital reception signals (e.g., 170-a, 170-b), based on the frequency responses at the receiver bands (block 348).

It is to be noted that, with reference to FIG. 3, some of the blocks can be integrated into a consolidated block or can be broken down to a few blocks and/or other blocks may be added. It is to be further noted that some of the blocks are optional. It should be also noted that whilst the flow diagrams are described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A method for mitigating self-interference in a Frequency-Division Duplex (FDD) transceiver, the method comprising:
outputting, by a transmitter of the FDD transceiver, a transmission signal in a transmission band for transmission by a transmitter antenna;
sampling the transmission signal, at the transmitter antenna, to provide a sample transmit signal to an adaptive filter that is coupled between the transmitter and a receiver of the FDD transceiver;
mitigating or rejecting, by a tunable notch filter that is located between a receiver antenna and the receiver, a main lobe of a leakage of the transmission signal at the receiver antenna;
scaling the sample transmit signal, by the adaptive filter, to generate a canceling signal that is injected into the receiver for frequency-selective compensation, at the receiver, of the leakage of the transmission signal in at least two receiver bands, the adaptive filter being configured to have a frequency-selective filter response that individually targets each of the at least two receiver bands for achieving the frequency-selective compensation; and
combining the canceling signal and an output signal that is associated with an output of the tunable notch filter, resulting in a compensated signal, being the output signal compensated for the leakage of the transmission signal in the receiver bands.

2. The method of claim 1, wherein the receiver bands are on one side of the transmission band.

3. The method of claim 1, wherein the receiver bands are at opposite sides of the transmission band.

4. The method of claim 1, wherein the receiver comprises a plurality of receiver channels, each receiver channel of the receiver channels: (1) being tuned to a distinct receiver band of the receiver bands, and (2) including a narrowband analog-to-digital converter (ADC); and
wherein, for each receiver channel of the receiver channels, the method further comprises:
converting, by the narrowband ADC of the respective receiver channel, a component of the compensated signal that is in the distinct receiver band to which the respective receiver channel is tuned, to provide a digital reception signal.

5. The method of claim 4, further comprising:
filtering the compensated signal, by at least two tunable bandpass filters, each tunable bandpass filter of the tunable bandpass filters being configured to pass the component of the compensated signal in one of the receiver bands to the receiver channel that is tuned to the respective receiver band, thereby increasing a selectivity of the receiver channels.

6. The method of claim 4, wherein sampling the transmission signal at the transmitter antenna also provides a second sample transmit signal, and wherein the method further comprises:
for each receiver band of the receiver bands, digitizing a component of the second sample transmit signal associated with the respective receiver band, by an additional analog-to-digital converter, to generate a digitized transmission signal component associated with the respective receiver band.

7. The method of claim 6, further comprising:
calculating, by a digital controller, based on the digitized transmission signal components associated with the receiver bands and the digital reception signals provided by the receiver channels, a frequency response at each of the receiver bands, the frequency response at each of the receiver bands being defined as a ratio of a magnitude and phase of the digital reception signal that is associated with the respective receiver band to the magnitude and phase of the digitized transmission signal component that is associated with the respective receiver band.

8. The method of claim 7, wherein the adaptive filter has multiple taps, and wherein the method further comprises:
configuring filter weights for each of the taps, by the digital controller, based on the frequency response at each of the receiver bands; and
realizing, by the adaptive filter, the filter weights.

9. The method of claim 7, further comprising:
compensating for the leakage of the transmission signal in the digital reception signals, by the digital controller, based on the frequency response at each of the receiver bands.

10. A Frequency-Division Duplex (FDD) transceiver, comprising:
a transmitter configured to output a transmission signal in a transmission band for transmission by a transmitter antenna;
a receiver;
a sampling unit configured to sample the transmission signal, at the transmitter antenna, to provide a sample transmit signal;
a tunable notch filter that is located between a receiver antenna and the receiver, the tunable notch filter being configured to mitigate or reject a main lobe of a leakage of the transmission signal at the receiver antenna; and
an adaptive filter, coupled between the transmitter and the receiver, and configured to scale the sample transmit signal to generate a canceling signal that is injected into the receiver, for frequency-selective compensation, at the receiver, of the leakage of the transmission signal in at least two receiver bands, the adaptive filter being configured to have a frequency-selective filter response that individually targets each of the at least two receiver bands for achieving the frequency-selective compensation;
wherein the canceling signal is combined with an output signal that is associated with an output of the tunable notch filter, resulting in a compensated signal, being the output signal compensated for the leakage of the transmission signal in the receiver bands.

11. The FDD transceiver of claim 10, wherein the receiver bands are on one side of the transmission band.

12. The FDD transceiver of claim 10, wherein the receiver bands are at opposite sides of the transmission band.

13. The FDD transceiver of claim 10, wherein the receiver comprises:
a plurality of receiver channels, each receiver channel of the receiver channels: (1) being tuned to a distinct receiver band of the receiver bands, and (2) including a narrowband analog-to-digital converter (ADC) configured to convert a component of the compensated signal that is in the distinct receiver band, to provide a digital reception signal.

14. The FDD transceiver of claim 13, further comprising:
at least two tunable bandpass filters, each tunable bandpass filter of the tunable bandpass filters being configured to pass the component of the compensated signal in one of the receiver bands to the receiver channel that is tuned to the respective receiver band, thereby increasing a selectivity of the receiver channels.

15. The FDD transceiver of claim 13, wherein the sampling unit is further configured to provide a second sample transmit signal, and wherein the FDD transceiver further comprises:
additional analog-to-digital converters (ADCs), each additional ADC of the additional ADCs being configured to digitize a component of the second sample transmit signal associated with a respective receiver band of the receiver bands, to generate a digitized transmission signal component associated with the respective receiver band.

16. The FDD transceiver of claim 15, further comprising:
a digital controller configured to calculate, based on the digitized transmission signal components associated with the receiver bands and the digital reception signals provided by the receiver channels, a frequency response at each of the receiver bands, the frequency response at each of the receiver bands being defined as a ratio of a magnitude and phase of the digital reception signal that is associated with the respective receiver band to the magnitude and phase of the digitized transmission signal component that is associated with the respective receiver band.

17. The FDD transceiver of claim 16, wherein the adaptive filter has multiple taps, wherein the digital controller is further configured to configure filter weights for each of the taps, based on the frequency response at each of the receiver bands, and wherein the adaptive filter is further configured to realize the filter weights.

18. The FDD transceiver of claim 17, wherein the digital controller is configured to configure the filter weights by applying a multi-band algorithm at the receiver bands.

19. The FDD transceiver of claim 16, wherein the digital controller is further configured to compensate for the leakage of the transmission signal in the digital reception signals, based on the frequency response at each of the receiver bands.

20. The FDD transceiver of claim 10, further comprising:
a second tunable notch filter, provided in series with the adaptive filter, in order to increase a dynamic range of the adaptive filter.
